(19) United States
(12) Patent Application Publication
(10) Pub. No.: US 2020/0175589 A1
(43) Pub. Date: Jun. 4, 2020

(54) System and Methodology for Collaborative Trading with Share and Follow Capabilities

(71) Applicant: Matrix Financial Technologies, Inc., Irvine, CA (US)

(72) Inventors: Eyal Shachar, Santa Ana, CA (US); Mark Peter Grieco, Orange, CA (US); Steven Dwight Albin, Irvine, CA (US); Eyal Marmareli, Santa Ana, CA (US)

(73) Assignee: Matrix Financial Technologies, Inc., Irvine, CA (US)

(21) Appl. No.: 16/204,018

(22) Filed: Nov. 29, 2018

(51) Int. Cl. G06Q 40/04; H04L 29/06

(52) U.S. Cl. CPC G06Q 40/04; H04L 63/104; H04L 63/102

(57) ABSTRACT

A system and methodology which permits users to share access to functionalities including those that analyze and execute trades of various financial instruments. While some information and activities associated with a user may be kept private and not shared with or made available to other users, other information and activities of that same user can be selectively made available to other individual users and/or groups of users. The determination as to whether information and/or activities of a user is available to other individual users can be made based upon a combination of preferences as specified by any or all of (i) the user creating the information and/or engaging in the activities; (ii) another user desiring to access the information and/or activities of the Sharing User; (iii) a group administrator and/or group decision making associated with a group of users having common interests; and/or (iv) preferences and controls set by one or more system administrators.

### FIELD OF THE INVENTION

The present invention is directed generally to systems and methodologies for providing collaborative functionalities between and among common users of applications and online communities and more particularly to systems and methodologies which provide such collaborative functionalities in the context of applications and online communities associated with the trading of financial instruments such as stocks, options, currencies and commodities.

### BACKGROUND OF THE INVENTION

Online applications and communities are prevalent in today's world. These applications touch on a great many aspects of our lives including, how we create documents, how we schedule our appointments, how we bank, how we conduct other financial transactions and how we get our news. These are just a few examples and there are perhaps hundreds or thousands of other areas where such applications improve life experiences as well as business operations.

These applications may reside in the cloud or may be local to a client device. By contrast, related communities are typically hosted remotely so that many users may access the features and functionality of the communities from various devices and from practically any geographical location. In the context of communities, users with common interests may share information, post comments and interact in other ways with respect to these common interests as well as in connection with related and unrelated matters.

For example, there exist various online communities associated with the trading of financial instruments such as stocks, bonds, options and commodities. These communities bring together traders and experts so that they may interact with each other with respect to the subject matter of common interest. For example, some communities may be limited to stock trading in general or to specific aspects of stock trading such as the trading of specific stocks, trading strategies, recommendations and/or other subject matter.

These online communities may provide various functionalities and capabilities which may include some or all of the following: message boards, forums, articles/blogs by experts and non-expert users, stock data, user and expert trading results and/or other aspects. By way of example, an online community might target traders of energy stocks. Such a community might selectively permission users based on whether they have registered on the community website or not. This same community may provide a forum for users to read and post messages from other users as well as to provide articles from experts in the field of energy stocks. Further, this community might allow users to provide data associated with their portfolios and allow for other users to provide commentary and/or suggestions.

Apart from online communities, traders of stocks and other financial instruments also have available to them various applications and online services designed specifically for their requirements. These applications include brokerage platforms, trading system applications as well as applications for performing technical analysis as well as others. Tools for trading stocks and other instruments have also been combined with brokerage platforms providing platforms with fairly robust capabilities for traders desiring to manage and trade their own portfolios.

While there are a great many applications applicable to trading and while there are many different communities associated with and for the benefit of traders, the integration and combination of the two, including the ability to leverage the capabilities of both in a combined way has, to date, been largely overlooked. For example, it is generally not possible for one trader to easily leverage to trading experiences of other users on a platform to make better trading decisions. As another example, it is generally not possible for multiple traders to collaborate on a trading strategy in a well-organized and efficient way despite each of these traders having access to the same tools and the same general information.

### SUMMARY OF THE INVENTION

It is thus a primary object of the invention to provide a system and methodology that addresses the shortcomings of the prior art as discussed above.

It is another object of the present invention to provide a system and methodology which provides a computer implemented platform which offers collaborative capabilities between and among users of the platform.

It is a further object of the present invention to provide a system and methodology which provides a computer implemented trading platform which offers collaborative capabilities between and among users of the trading platform.

It is a still further object of the present invention to provide the foregoing computer-implemented platform in the form of a cloud based solution.

It is a yet further object of the present invention to provide a computer implemented platform which includes various share and follow features enabling users of such platform to share and view information and activities with other users of the platform.

It is another object of the present invention to provide a computer implemented platform which features various share and follow features in the context of a trading platform for analysing, evaluating and implementing trades.

It is a yet further object of the present invention to provide collaborative share and follow capabilities in a trading platform wherein one or more proposed or actual trades can be shared with and accessed by other users of the trading platform.

It is a yet further object of the present invention to provide collaborative share and follow capabilities in a trading platform wherein both sharing and following users can selectively determine which trades will be shared and followed, respectively, depending upon one or more selected criteria.

A primary objective the invention disclosed herein is a system and methodology which provides a platform for collaborative share and follow capabilities through which various users of the platform may interact and selectively permit and obtain access to the information provided by users and/or the activities undertaken by users. According to the teachings of the present invention, this platform permits users to create and join groups of users for communication as well as for periodic access to information concerning the activities of other users.

In some embodiments of the present invention, the disclosed platform comprises a cloud-based trading platform which permits users to analyze and execute trades of various financial instruments. While some information and activities associated with a user may be kept private and not shared with or made available to other users, other information and activities of that same user can be selectively made available to other individual users and/or groups of users. The determination as to whether information and/or activities of a user (“the Sharing User”) is available to other individual users can be made based upon a combination of preferences as specified by any or all of (i) the user creating the information and/or engaging in the activities (the Sharing User); (ii) another user desiring to access the information and/or activities of the Sharing User (the “Accessing User”); (iii) a group administrator and/or group decision making associated with a group of users having common interests; and/or (iv) preferences and controls set by one or more system administrators.

In the context of a trading system platform with collaborative share and follow capabilities as described herein, and as one example, individual and/or groups of actual or proposed trades can be selectively shared with other users of the platform. This sharing of trades may be further described as occurring in various different implementations. For example, the sharing may comprising providing the Accessing User with access to information about the proposed or actual trade in raw form or via a tool such as a trade analysis and charting tool also available through the platform.

From the point of view of the Sharing User, that user can specify the type of information and activities for which sharing will be permitted as well as the individual users, groups of users and/or characteristics of users which will be permitted to access the shared activities and information. From the point of view of the Accessing User, that user may “follow” various activities and/or information according to preferences specified by that user and/or by groups of users to which that user belongs. In the context of a trading platform, Accessing Users might specify parameters for determining which information and activities to follow, such parameters to include, for example, the identity of and/or characteristics associated with the Sharing User, the asset type associated with the activity or the information, the market associated with the activity or the information, the type of trading setup discussed or used, the tool involved in the activity or referenced in the information as well as a great many other possible parameters.

### BRIEF DESCRIPTION OF THE DRAWINGS

FIG. 1 is a diagram depicting the major components of the system of the present invention including the Collaborative Functionality Control Engine (CFCE) of the present invention in a preferred embodiment thereof;

FIGS. 2-3 are exemplary user interfaces demonstrating the process of and ability for one user to follow the trading activity of another user according to one embodiment of the present invention; and

FIG. 4 is exemplary user interface demonstrating the process of and ability for a followed/sharing user to make his or her trading activity available to a group of other users according to one embodiment of the present invention.

### DETAILED DESCRIPTION OF THE INVENTION

The present disclosure will now be described in terms of various exemplary embodiments. This specification discloses one or more embodiments that incorporate features of the present embodiments. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. The skilled artisan will appreciate that a particular feature, structure, or characteristic described in connection with one embodiment is not necessarily limited to that embodiment but typically has relevance and applicability to one or more other embodiments.

In the several figures, like reference numerals may be used for like elements having like functions even in different drawings. The embodiments described, and their detailed construction and elements, are merely provided to assist in a comprehensive understanding of the present embodiments. Thus, it is apparent that the present embodiments can be carried out in a variety of ways, and does not require any of the specific features described herein. Also, well-known functions or constructions are not described in detail since they would obscure the present embodiments with unnecessary detail.

The description is not to be taken in a limiting sense, but is made merely for the purpose of illustrating the general principles of the present embodiments, since the scope of the present embodiments are best defined by the appended claims.

It should also be noted that in some alternative implementations, the blocks in a flowchart, the communications in a sequence-diagram, the states in a state-diagram, etc., may occur out of the orders illustrated in the figures. That is, the illustrated orders of the blocks/communications/states are not intended to be limiting. Rather, the illustrated blocks/communications/states may be reordered into any suitable order, and some of the blocks/communications/states could occur simultaneously.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of’ “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be understood that, although the terms first, second, etc. may be used herein to describe various elements, these elements should not be limited by these terms. These terms are only used to distinguish one element from another. For example, a first element could be termed a second element, and, similarly, a second zo element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

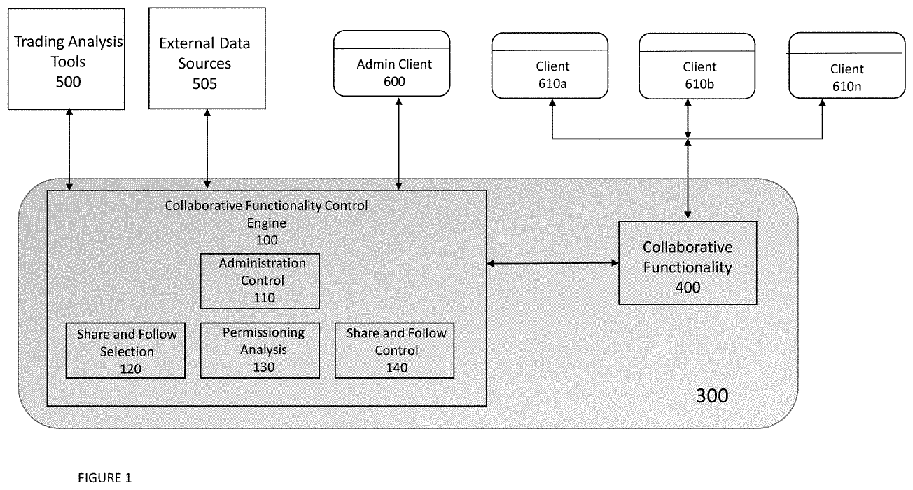

With reference now to FIG. 1, the system of the present invention, in a preferred embodiment thereof, is now described. According to a preferred embodiment, Collaborative Functionality Control Engine (CFCE) 100 and collaborative functionality 400 reside on a single cloud based server 300 although it is also possible for each of CFCE 100 and collaborative functionality 400 to reside on separate servers. It is also possible for components of CFCE 100 and/or collaborative functionality 400 to themselves be distributed among multiple servers.

In any event, collaborative functionality 400 may be accessed through the internet or any other private or public network by one or more clients 610. Each of clients 610a, 610b . . . 610n may be personal computers, laptops, handheld computing devices such as smartphones or tablets or any other device capable of providing the required connectivity and display. Clients 610 interact with collaborative functionality 400 such that data may be communicated between them and such that collaborative functionality 400 may process collaboration related requests made by Clients 610.

By way of example, collaborative functionality 400 may be one or more computer implemented applications which reside on server 300 and which provide the ability for users to interact in collaborative ways such as (i) through the posting and reading of message boards and related forums, (ii) through the posting and reading of blogs and other content, (iii) through the transmission and receipt of one to one and one to many communications between users; (iv) through the notification to users of events or communications requiring their attention; and (v) through the indication and selection of interests related to subject matter and otherwise. As will be understood by one of skill in the art, the applications comprising collaborative functionality 400 may be implemented through the use of commercial software and/or services to include message board/forum software and other similar applications as more fully described below.

Collaborative Functionality Control Engine (CFCE) 100 interacts with collaborative functionality 400 to provide the integration and implementation of various applications, tools and data sources with the capabilities associated with collaborative functionality 400 as more fully set forth herein. In order for this to occur, collaborative functionality 400 is designed to allow control of specific application features, such as how the user interface is presented on client 610, by CFCE 100 as well as which functionality is and is not available to a specific user of collaborative functionality 400.

Turning now to the specific components of CFCE 100, as they exist in a preferred embodiment, share and follow selection component 120 functions to permit users to select those “elements” that they wish to share and follow with respect to how those elements interact within collaborative functionality 400. In this context, the term “elements” may mean, for example, which users should be shared or followed. So, for example, a user (User A) may, via client 610a, indicate an interest in following certain activities conducted by User B. Share and follow selection 120 manages the receipt and storage of the selections made by users.

Thus, in one particular embodiment, User A may indicate, via an interface generated by collaborative functionality 400 at client 610a, that User A desires to follow all trades planned to be executed by User B during the next 30 days. In this case, collaborative functionality will transfer information reflecting such preference to share and follow selection component 120 and share and follow selection component will store such information so that only the desired “elements” are made available to User A in the case of this example. In an alternate embodiment, the selection of desired elements may be communicated directly from one of the clients 610 to share and follow selection component 120 of CFCE 100 without involving collaborative functionality 400. In this case, share and follow selection component 120 (or another component within CFCE 100) would be responsible for interacting with User A via client 610 so as to ascertain the desired selections.

In either case, share and follow section component 120 manages the inter-relationship between each user and the elements that they are sharing and/or following. These inter-relationships are stored within CFCE 100 and are used by share and follow control component 140 to implement and manage access by each of the users to each of the elements when the time comes that access or presentation is requested. As an example, the following data may be stored within CFCE 100 with respect to various sharing users and the elements to which they are related.

TABLE 1

| USER | SHARE | SHARE SCOPE |
|---|---|---|
| A | Planned Currency | Paid Currency |
| | Trades | content |
| | | subscribers |
| | | Users joining |
| | | before Jan. 1, 2018 |
| A | Trades of AAPL stock | Any user |
| | | following User |
| | | A generally |
| B | All option trading | Paid option |
| | content | content |
| | | subscribers |
| C | Blog content regarding | Energy stock |
| | past energy stock | followers |
| | trades | Level 3 paid |
| | | subscribers |

TABLE 2

| | FOLLOW | |
|---|---|---|
| USER | AUTHORIZATIONS | FOLLOW |
| D | Joined Mar. 1, 2018 | Past energy |
| | Energy Stock Follower | stock blog |
| | | content (User |
| | | C) |
| E | Joined Jan. 9, 2014 | Planned |
| | Follow User A, User D, | currency |
| | User L | trades (User |
| | | A) |
| | | AAPL stock |
| | | trades (User |
| | | A) |
| F | Joined May 6, 2017 | Planned |
| | | currency |
| | Follow all trades relating | trades (User |
| | to AAPL stock | A) |
| | Level 4 paid subscriber | |
| G | Joined April 4, 2014 | Option trading |
| | | content (User |
| | Paid option content | B) |
| | subscriber | Planned |
| | | currency |
| | | trades (User |
| | | A) |

With respect to the tables above, permissioning analysis component 130 of CFCE 100 operates to determine which follows should be permitted and which should not. Thus, the following users (Table 2) can only follow (third column) the elements for which the sharing users (Table 1) have specified criteria met by the following users. By way of example, User D can follow User C's past energy stock blog content because User D has indicated a desire to follow energy stock content. Similarly, User E can follow User A's planned currency trades because User E joined before Jan. 1, 2018. User E can also follow User A's AAPL stock trades because User E is following user A generally. Note, for example, that User E could not follow User B's option trading content because User E is not a paid option content subscriber as is required by User B.

In some embodiments, following users may be permitted to follow most or all of the elements that they are entitled to regardless of whether they specifically request to follow each of those elements. While in other embodiments, in order to follow specific elements, following users must both specifically request to follow each element as well as be entitled to follow each element as explained above. In some embodiments, one or more administrators may determine which elements are followed by following users and whether or not those follows will require a specific request by the following users. Various options in terms of how share and follow determinations are made are available as would be recognized by one of skill in the art. As noted, share and follow selection component 120 functions to permit sharing users to specify their sharing requirements and to permit following users to specify their following preferences. Permissioning analysis component 130 interacts with the share and follow database created by share and follow selection component 120 so as to determine whether follow requests will be honored. Finally share and follow control component 140 implements access to (or prevention of access to) various elements/content in concert with collaborative functionality 400.

FIG. 1 also includes trading analysis tools 500. This may be one or more external program or tool that interacts with collaborative functionality 400 so as to provide an integrated environment including both tools and community aspects which are directly related to those tools. While the description herein is provided in the context of trading tools and platforms and associated communities, the scope and spirit of the present invention is not necessarily limited thereto. For example, the disclosed teachings relating to the integration of tools/applications with related community aspects can be applied to other areas of subject matter such as tools and communities associated with politics, sports betting, education, music production and a vast number of other areas.

In the context of the present description, trading analysis tools 500 represents one or more tools used by traders to analyze and/or implement trades of financial instruments. By way of example, these tools may include a brokerage platform, a technical analysis application, a money management platform and/or other applications designed to assist with or permit the trading of financial instruments. According to the teachings of the present invention, these trading analysis tools 500 are integrated, via CFCE 100, with the communal aspects provided by collaborative functionality 400 so zo that sharing and following of activities associated with trading analysis tools 500 is provided in a way not heretofore possible.

In some embodiments, one or more external data sources 505 are also provided in a manner that they can interact with CFCE 100 and ultimately collaborative functionality 400. In this context, these external data sources may include financial instrument data such as stock trade data, market data and/or other data related to the applicable subject matter that may be integrated with the communal aspects of collaborative functionality 400 as described herein. As such, selected data provided by external data sources 505 may be selectively made available to following users subject to permissioning requirements as described above.

Also shown in FIG. 1 is admin client 600. Admin client 600 may be a personal computer, laptop, handheld computing device such as a smartphone or tablet or any other device capable of providing the required connectivity and display. Admin client 600 may be used by an administrator to interact with CFCE 100 so as to manage share and follow configurations and preferences as more fully set forth herein. By way of example only, a system administrator may work at admin client 600 to interact with CFCE 100 so as to set specific elements which may be followed by all users regardless of any characteristics of the following user. This permissioning may be implemented by causing collaborative functionality 400 to always permit access to the specified elements, for example, all users might be set up to always see an element described as a general market conditions blog.

Server 300 (and other servers not shown but upon which various components of the present invention may reside) may include electronic storage, one or more processors, and/or other components. The servers may also include communication lines, or ports to enable the exchange of information with a network and/or other computing platforms. The servers may include a plurality of hardware, software, and/or firmware components operating together to provide the functionality attributed herein to CFCE 100, collaborative functionality 400, trading analysis tools 500 and/or external data sources 505.

Electronic storage associated with the servers may comprise non-transitory storage media that electronically stores information. The electronic storage media of zo electronic storage may include one or both of system storage that is provided integrally (i.e., substantially non-removable) with servers and/or removable storage that is removably connectable to the servers via, for example, a port or a drive.

Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processors, information received from servers, information received from user terminals and/or other information that enables the servers to function as described herein.

While an exemplary architecture is described above, it will readily be understood by one of skill in the art, that an unlimited number of architectures and computing environments are possible while still remaining within the scope and spirit of the present invention. Now that a high level description of the components and architecture associated with the system and methodology of the present invention has been provided, the specific aspects of the novel permissioning methodologies implemented by CFCE 100 and collaborative functionality 400 are discussed.

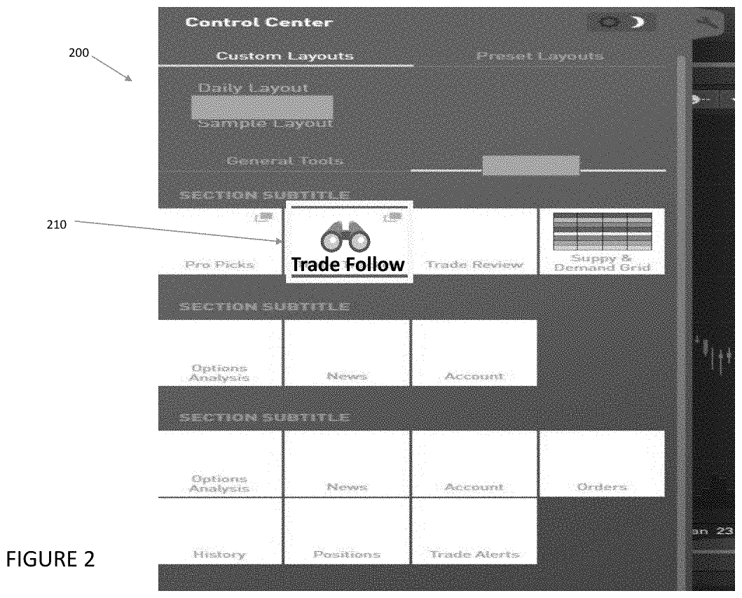

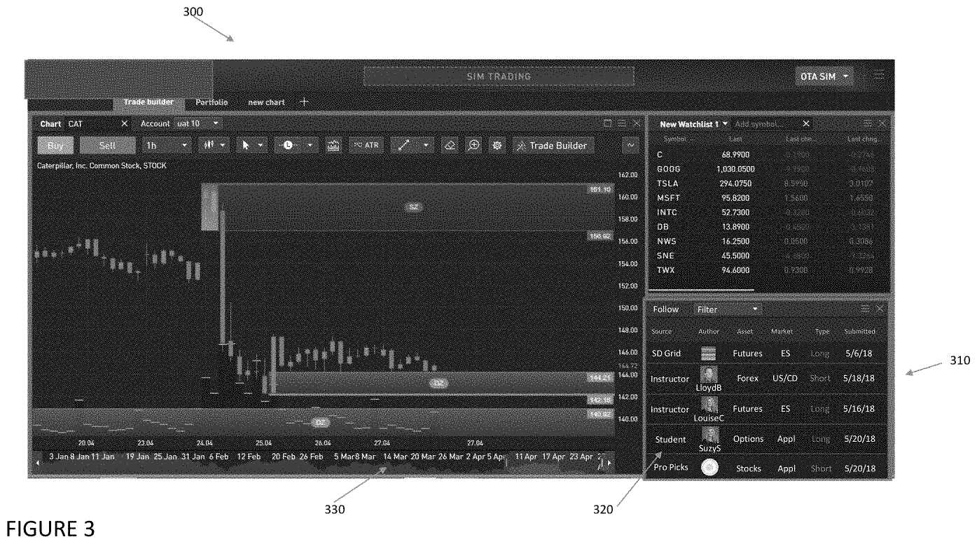

With reference now to FIG. 2 and FIG. 3, exemplary user interfaces 200 and 300 are respectively shown and which permit a user, in one embodiment, to follow the trades made or proposed to be made by another user. In FIG. 1, a user, via client 610, may click on TRADE FOLLOW button 210 from a control center page which will then produce another page such as that shown in FIG. 3, for example. In this view, window 310 lists all of the traders being followed by a user along with exemplary information about each of those traders. By clicking on one of the rows associated with one of the followed traders, such as “Student” in row 320, one or more of the traders planned or executed trades can be presented in window 330.

One of the unique aspects of this novel feature is that the functionality employed to generate the trade analysis originally used by the followed user and shown in window 330 and the results thereof are shared and made available to a following user. In some embodiments, CFCE 100 may require that the following user has the necessary licenses/rights to the access the same tool that was initially used by the followed user while in other embodiments, this is not necessary. This unique ability for followed and following users to share more than just textual information (they are able to share functionality as well as input provided to that functionality and the results of functionality acting on the inputs) offers many advantages well beyond what is presently available to traders or other users of common platforms that desire to share the benefits of one user's use of a particular function and/or application.

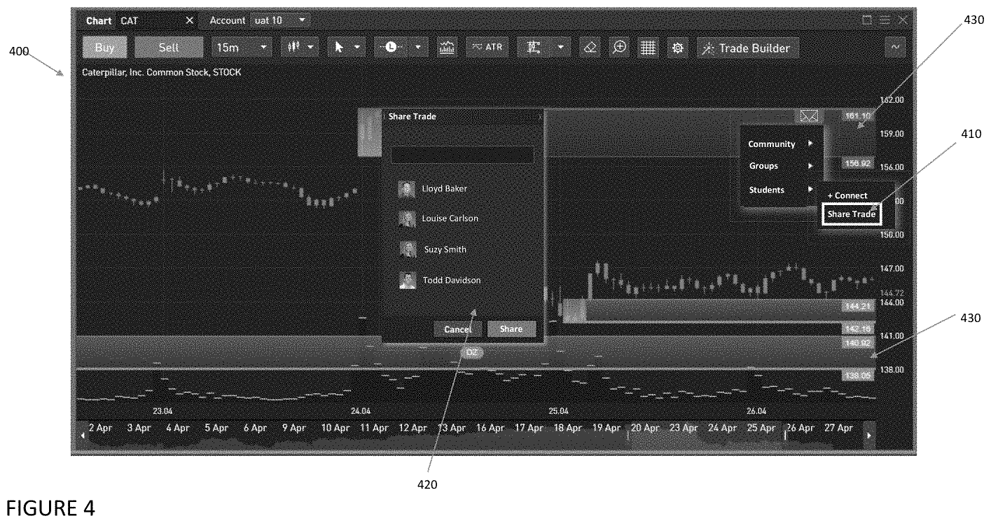

Turning now to FIG. 4, an exemplary user interface 400 is provided in connection with the following description of how a sharing user may share trading activity (and/or access to other functionality) with a group of following users. In this case, a sharing user may desire to share, for example, a specific trade setup with a group of following users who might be interested in the same. The sharing user, in this case, has charted and developed a potential trade of the common stock of Caterpillar (CAT). In particular, supply and demand zones 430 have been created by the sharing user via a trading analysis tool available to that sharing user. In creating these zones, the sharing user has creating the framework for potential trading activities associated with CAT stock.

The sharing user may share this setup with a group of following users by clicking on the “share trade” button 410 which has been navigated to via higher level menus. As can be seen in FIG. 4, and only by way of example, the sharing user may have selected the “Groups” menu to generate the “share trade” button. Upon clicking the “share trade” button, a list 420 of a potential group of following users is presented via the interface. In some embodiments, this may be a default list of following users previously designated as following this sharing user, following this particular instrument (CAT stock), following this type of trade and/or any other connection or expression of interest between a following user and this sharing user or the activity that this sharing user is seeking to share.

In this case, the share trade list 420 includes four proposed users with whom the trade setup could be shared. This list may be modified by the sharing user depending on preferences and additional lists generated by different criteria may also be available to the sharing user which he or she can use to supplement the shared with list. In some embodiments, once the action of sharing is complete and the sharing user has finalized the shared with list, the system may notify each of the following users that this trade has been shared with them and may also provide ready access for those following users to access the trade setup via the relevant application functionality. Notification to the following users may be through email, text, system notification or various other means. The sharing user may also be notified when any or all of the following users have accessed the shared trade.

Following users for this trade may provide textual commentary and/or proposed modifications or supplemental input to the proposed trade which may be shared with the sharing user and/or some or all of the following users in the group. This enables the potential for a group collaboration on the proposed trade with some or all of the following users in the group being able to share and demonstrate ideas in a uniquely interactive way.

CFCE 100 may also provide additional features in some embodiments. For example, CFCE 100 can notify potential following users when an action (e.g. trade setup, new relevant content posted, etc.) that meets the follow parameters specified by those potential following users is posted/activated etc. In addition, CFCE 100 may, in some embodiments, send invitations to potential following users to solicit them to join specific groups and/or follow specific actions based on preferences and/or previous interests known about such following users.

Users maybe provided with the ability to create groups of users which share interests. Users creating these groups may be made aware of potential group members based on which users they may have previously connected with and/or based on available tools for searching for other users with similar interests and/or users that have conducted similar activities. In some embodiments, following users which have been provided membership within a group and/or have been provided access to an activity of a sharing user may forward an invitation to another user to join the group and/or forward the ability to access the activity to another user, respectively.

While the present invention has been described primarily in the context of a financial trading platform, the teachings of the present invention are by no means limited thereto and can be applied to any platform which is used and accessed by multiple users. Examples include online educational platforms, gaming applications, productivity applications such as word processors and spreadsheet applications and the like.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

1. A collaborative system permitting share and follow capabilities and configured to selectively enable the sharing of application results, said collaborative system comprising:
one or more processors configured to execute computer program modules, said computer program modules comprising:
at least one application providing results, said application receiving input from a sharing user being authorized to access said at least one application according to a first authorization, and providing said results based on said input; and
a collaborative functionality control engine which makes a permissioning determination to selectively permission access by a following user to said input, said results and functionality of said at least one application;
wherein
said collaborative functionality control engine makes a permissioning determination to grant access to said input, said results and said functionality of said at least one application in response to each of (a) one or more characteristics selectively determined by only said following user and that match shareable criteria as defined by only said sharing user and (b) said following user being authorized to access said at least one application according to a second authorization that is different than said first authorization, said matching and input into and recognition by said at least one application of said second authorization enabling said following user to obtain said access to each of (i) said input, (ii) said results and (iii) said functionality of said at least one application to permit said following user to modify said input from said sharing user to provide modified input from said following user for dissemination among said sharing user and another following user having (a) one or more characteristics selectively determined by only said another following user that match shareable criteria as defined by only said sharing user and (b) a third authorization to access said at least one application that is (i) input into and recognized by said at least one application and (ii) different from said first authorization and said second authorization, prior to said application implementing said modified input to obtain a corresponding result.

2. (canceled)

3. The system of claim 1 wherein said at least one application comprises a financial instrument analysis tool.

4. The system of claim 1 wherein said at least one application comprises a stock analysis and trading platform.

5. The system of claim 1 further comprising an administrative control module accessed by an administrator via an administrative client, said administrative control module receiving instructions from said administrator which are implemented as one or more rules associated with selective permissioning.

6. The system of claim 1 wherein said at least one application is a financial instrument analysis tool and said results is a trading setup.

7. The system of claim 6 wherein said trading setup comprises a stock trading setup.

8. The system of claim 1 wherein said at least one application comprises a community message board.

9. (canceled)

10. The system of claim 1 wherein each of said following users is selected by said sharing user.

11. A computer-implemented method of permitting share and follow capabilities and configured to selectively enable the sharing of application results, the method being implemented in a computer system comprising one or more processors configured to execute computer program modules, the method comprising the steps of:
a sharing user providing input to at least one application based on said sharing user being authorized to access said at least one application according to a first authorization, said at least one application providing results based on said input;
selectively making a determination to permission access to said input, said results, and functionality of said at least one application to a following user;
wherein a determination to grant access to said input, said results and said functionality of said at least one application is made in response to each of (a) one or more characteristics selectively determined by only said following user and that match shareable criteria as defined by only said sharing user and (b) said following user being authorized to access said at least one application according to a second authorization that is different than said first authorization, said matching and input into and recognition by said at least one application of said second authorization enabling said following user to obtain said access to each of (i) said input, (ii) said results and (iii) said functionality of said at least one application to permit said following user to modify said input from said sharing user to provide modified input from said following user for dissemination among said sharing user and another following user having (a) one or more characteristics selectively determined by only said another following user that match shareable criteria as defined by only said sharing user and (b) a third authorization to access said at least one application that is (i) input into and recognized by said at least one application and (ii) different from said first authorization and said second authorization, prior to said application implementing said modified input to obtain a corresponding result.

12. (canceled)

13. The method of claim 11 wherein said at least one application comprises a financial instrument analysis tool.

14. The method of claim 11 wherein said at least one application comprises a stock analysis and trading platform.

15. The method of claim 11 further comprising the step of receiving instructions from an administrator which are implemented as one or more rules associated with selective permissioning.

16. The method of claim 11 wherein said at least one application is a financial instrument analysis tool and said results are a trading setup.

17. The method of claim 16 wherein said trading setup comprises a stock trading setup.

18. The method of claim 11 wherein said at least one application comprises a community message board.

19. (canceled)

20. The method of claim 11 wherein each of said following users is selected by said a sharing user.
